(19) United States
(12) Patent Application Publication
(10) Pub. No.: US 2009/0255299 A1
(43) Pub. Date: Oct. 15, 2009

(54) Clothes Drier, Washing Machine, and Washing Machine with Clothes Drying Function

(75) Inventors: Naoki Hiro, Osaka (JP); Naoki Kitayama, Osaka (JP); Jyun Hirose, Osaka (JP); Motoki Kochi, Osaka (JP); Haruo Mamiya, Osaka (JP); Kenichiro Dohi, Osaka (JP); Kiyoshi Sarada, Osaka (JP); Sayaka Oyanagi, Osaka (JP)

Correspondence Address: RABIN & Berdo, PC, 1101 14TH STREET, NW, SUITE 500, WASHINGTON, DC, 20005, US

(73) Assignee: SANYO ELECTRIC CO., LTD., Osaka (JP)

(21) Appl. No.: 12/083,107

(22) PCT Filed: Sep. 25, 2006
(86) PCT No.: PCT/JP2006/318984

§ 371 Date: Apr. 4, 2008

(30) Foreign Application Priority Data
Oct. 7, 2005 (JP) 2005-295193
Dec. 27, 2005 (JP) 2005-376182

(51) Int. Cl. D06F 29/02; F26B 11/02; F26B 21/00; F26B 19/00

(52) U.S. Cl. 68/19; 34/132; 34/565; 34/63

(57) ABSTRACT

The present invention provides a clothe drier, a washing machine and a washing machine with a clothes drying function, which are improved in the effects of cleaning, deodorizing and sterilizing clothes with ozone, and permit easy replacement of an ozone generation element or safe control of the ozone. An ozone generator (40) generates ozone by applying silent discharge to air introduced therein. The ozone is sucked into a drying air duct (15) by rotation of a blower (20) and a drum (3) and mixed in air heated by a heater (21), and the resulting mixture is supplied into the drum (3) through an inlet (17). Thus, the ozone is supplied to clothes to be dried, thereby effectively deodorizing and sterilizing the clothes. Since the ozone generator (40) is disposed away from the drying air duct (15), the ozone generation element can be easily replaced. After completion of drying, no ozone is present in the drum (3) due to an oxidation reaction, so that the user is unlikely to be influenced by the ozone when taking the clothes out of the drum (3).

### TECHNICAL FIELD

The present invention relates to a clothes drier, a washing machine and a washing machine with a clothes drying function, which are improved in the effects of cleaning, deodorizing and sterilizing clothes to be laundered.

### BACKGROUND ART

Clothes driers are conventionally known which are configured to circulate hot air generated by a heater through a circulation duct and supply ozone generated by an ozone generator to clothes in a drying chamber for deodorization and sterilization of the clothes. A quilt drier of this type is proposed by invention disclosed in Patent Document 1.

Further, a washing machine employing deodorization/sterilization means of the aforesaid type is proposed by invention disclosed in Patent Document 2.

### Patent Document 1: Japanese Unexamined Patent Publication No. 4-371199

### Patent Document 2: Japanese Unexamined Patent Publication No. 2002-320792

### DISCLOSURE OF THE INVENTION

### Problems to be Solved by the Invention

Where the ozone is supplied to a wet (or moistened) quilt by the quilt drier disclosed in Patent Document 1, however, water contained in the quilt prevents the ozone from infiltrating into the quilt. This is because the ozone has a lower solubility unless the ozone is present at a very high concentration. Therefore, the drier fails to provide improved deodorization and sterilization effects.

The washing machine disclosed in Patent Document 2 also suffers from the same problem as the invention disclosed in Patent Document 1, because the ozone is supplied to wet clothes. Unless the ozone is supplied to the clothes for a long period of time or the ozone concentration is significantly increased, water contained in the clothes prevents the ozone from infiltrating into the clothes. Therefore, the washing machine fails to provide sufficient deodorization and sterilization effects.

An ozone generation element of the ozone generator (including, for example, a substrate and electrodes for generating ozone by way of electric discharge) is often disposed in the circulation air duct. In this case, replacement of the ozone generation element is troublesome.

Further, there is a constant demand for improving a technique for safely controlling the ozone in use.

The ozone is capable of decomposing dirt on the clothes, thereby also providing a cleaning effect. In view of the foregoing, it is a principal object of the present invention to provide a clothes drier, a washing machine and a washing machine with a clothes drying function, which are improved in the effects of cleaning, deodorizing and sterilizing clothes with ozone.

It is another object of the present invention to provide a clothes drier, a washing machine and a washing machine with a clothes drying function, which permit easy replacement of an ozone generation element.

It is further another object of the present invention to provide a clothes drier, a washing machine and a washing machine with a clothes drying function, which permit safe ozone control.

### Means for Solving the Problems

According to an inventive aspect of claim 1, there is provided a clothes drier which comprises: a treatment tub in which clothes are dried; a drying air duct having opposite ends and configured to feed air supplied from one of the opposite ends into the treatment tub, the other end being connected to the treatment tub; an air blowing unit provided in the drying air duct and configured to generate an air stream for feeding the air supplied from the one end into the treatment tub through the other end; a heating unit provided in the drying air duct for heating air flowing through the drying air duct; and an ozone generator disposed outside the drying air duct for generating ozone from air sucked from an inlet thereof and releasing the ozone from an outlet thereof, the outlet being connected to a portion of the drying air duct upstream of the air blowing unit with respect to an air flowing direction.

With this arrangement, the outlet of the ozone generator is connected to the portion of the drying air duct upstream of the air blowing unit with respect to the air flowing direction. The ozone is generated from the external air sucked from the inlet of the ozone generator, and released from the outlet. The inside of the ozone generator is kept at a negative pressure, and the ozone generated from the external air sucked from the inlet is released from the outlet into the drying air duct by the negative pressure. Therefore, the ozone generator has a simplified mechanism without the need for providing a special device (e.g., an air pump) for releasing the generated ozone. Since the ozone is supplied to the clothes to be dried, the clothes are effectively deodorized and sterilized. Further, the ozone generator is disposed outside the drying air duct, permitting easy replacement of an ozone generation element thereof.

According to an inventive aspect of claim 2, there is provided a clothes drier which comprises: a treatment tub in which clothes are dried; a drying air duct having opposite ends and configured to feed air supplied from one of the opposite ends into the treatment tub, the other end being connected to the treatment tub; an air blowing unit provided in the drying air duct and configured to generate an air stream for feeding the air supplied from the one end into the treatment tub through the other end; a heating unit provided in a portion of the drying air duct downstream of the air blowing unit with respect to an air flowing direction in the drying air duct for heating air flowing through the drying air duct; an ozone generator disposed outside the drying air duct for generating ozone from air sucked from an inlet thereof and releasing the ozone from an outlet thereof, the inlet being connected to a portion of the drying air duct located between the air blowing unit and the heating unit, the outlet being connected to a portion of the drying air duct downstream of the heating unit with respect to the air flowing direction.

With this arrangement, the ozone generator having the inlet connected to the portion of the drying air duct located between the air blowing unit and the heating unit and the outlet connected to the portion of the drying air duct downstream of the heating unit with respect to the air flowing direction, serves as a bypass of the drying air duct. Therefore, a part of the air flowing through the drying air duct flows into the ozone generator from the inlet, and the ozone is generated in the ozone generator and forced out into the drying air duct through the outlet by air continuously flowing into the ozone generator from the inlet. Therefore, the ozone generator has a simplified construction without the need for introducing air into the ozone generator from the outside for the generation of the ozone and for providing a special device for ejecting the generated ozone. Since the ozone is supplied to the clothes to be dried, the clothes are effectively deodorized and sterilized. Further, the ozone generator is disposed outside the drying air duct, permitting easy replacement of an ozone generation element thereof.

According to an inventive aspect of claim 3, the clothes drier of claim 1 or 2 further comprising a dehumidifying unit provided in the drying air duct for dehumidifying the air flowing through the drying air duct, wherein the drying air duct is configured to circulate the air in the treatment tub with the one end thereof being connected to the treatment tub.

With this arrangement, the air in the treatment tub is circulated through the drying air duct. Thus, air containing moisture removed from the clothes is prevented from being released to the outside, while the air flowing through the drying air duct is dehumidified by the dehumidifying unit to be reused for the drying.

According to an inventive aspect of claim 4, there is provided a clothes drier which comprises: a treatment tub in which a drying operation is performed to dry clothes; an ozone generator which generates ozone; a dryness detecting unit which detects dryness of the clothes in the treatment tub; and an ozone supply controller which supplies the ozone generated by the ozone generator into the treatment tub after the dryness detected by the dryness detecting unit reaches a predetermined dryness level.

With this arrangement, the ozone supply controller supplies the ozone after the dryness detected by the dryness detecting unit reaches the predetermined dryness level. Therefore, the ozone effectively infiltrates into the clothes, thereby improving the clothes deodorizing and sterilizing effects.

According to an inventive aspect of claim 5, the clothes drier of claim 4 is characterized in that the ozone supply controller stops the supply of the ozone before completion of the drying operation performed in the treatment tub in consideration of time required for the ozone to be consumed in the treatment tub by an oxidation reaction before the completion of the drying operation.

With this arrangement, no ozone is present in the treatment tub due to the oxidation reaction after the completion of the drying operation. Therefore, a user is unlikely to be influenced by the ozone when taking the clothes out of the treatment tub.

According to an inventive aspect of the claim 6, the clothes drier of claim 4 or 5 is characterized in that a cooling step is performed to reduce an increased temperature of the clothes in the drying operation, wherein the ozone supply controller stops the supply of the ozone before.

With this arrangement, the ozone is supplied to the dried clothes with the temperature of the clothes being possibly at the highest level when the dryness reaches the predetermined dryness level. Therefore, the ozone efficiently infiltrates into the clothes, thereby improving the clothes deodorization and sterilization effects. Further, the user can readily take the clothes out of the treatment tub after the temperature of the dried clothes is reduced in the cooling step. The supply of the ozone is stopped before the completion of the cooling step. Therefore, no ozone is present in the treatment tub due to the oxidation reaction after the completion of the drying operation, so that the user is unlikely to be influenced by the ozone when taking the clothes out of the treatment tub.

According to an inventive aspect of claim 7, the clothes drier of claim 4 is characterized in that a cooling step is performed to reduce an increased temperature of the clothes after a drying step in the drying operation, wherein the ozone supply controller supplies the ozone into the treatment tub during the cooling step.

With this arrangement, the ozone is applied to the clothes which contain no excess moisture after completion of the drying step. Therefore, no moisture interferes with the ozone, so that the ozone efficiently infiltrates into the clothes. Thus, odorants remaining in the clothes are oxidized by the ozone to be thereby removed. Even if bacteria are still unremoved by the drying heat in the drying step, the bacteria are killed by the ozone.

According to an inventive aspect of claim 8, there is provided a clothes drier which comprises: a treatment tub in which clothes are dried; a drying air duct having opposite ends and configured to feed air supplied from one of the opposite ends into the treatment tub, the other end being connected to the treatment tub; an air blowing unit provided in the drying air duct and configured to generate an air stream for feeding the air supplied from the one end into the treatment tub through the other end; a heating unit provided in the drying air duct for heating air flowing through the drying air duct; an ozone generator disposed outside the drying air duct for generating ozone; and an ozone supply controller which supplies the ozone generated by the ozone generator into the treatment tub through the drying air duct; the clothes drier being configured to perform a drying step of introducing the heated air into the treatment tub to dry the clothes in the treatment tub by actuating the air blowing unit and the heating unit, and a cooling step of reducing a temperature of the clothes in the treatment tub after completion of the drying step; wherein the ozone supply controller supplies the ozone generated by the ozone generator into the treatment tub during the cooling step.

With this arrangement, the ozone is applied to the clothes which contain no excess moisture after the completion of the drying step. Therefore, no moisture interferes with the ozone, so that the ozone efficiently infiltrates into the clothes. Thus, odorants remaining in the clothes are oxidized by the ozone to be thereby removed. Even if bacteria are still unremoved by the drying heat in the drying step, the bacteria are killed by the ozone. The drying air duct is preferably configured such that the air in the treatment tub is circulated through the drying air duct with not only the other end but also the one end of the drying air duct being connected to the treatment tub.

According to an inventive aspect of claim 9, the clothes drier of claim 8 is characterized in that the cooling step includes a sterilizing step of supplying the ozone into the treatment tub in a first half period, and an ozone consuming step of causing the ozone supplied in the sterilizing step to be consumed by an oxidation reaction in a second half period, wherein the cooling step is terminated only after a lapse of a predetermined period from start of the ozone consuming step.

With this arrangement, the cooling step is terminated only after a lapse of the predetermined period (required for the ozone to be consumed by the oxidation reaction) from the start of the ozone consuming step during which the ozone supplied into the treatment tub in the sterilizing step is consumed by the oxidation reaction. This prevents an ozone odor from wafting to the outside, whereby the clothes can be safely taken out.

According to an inventive aspect of claim 10, there is provided a washing machine with a clothes drying function, comprising a clothes drier as recited in any one of claims 4 to 9, wherein the treatment tub is a tub in which water is contained and the clothes are washed and dehydrated before the drying of the clothes.

With this arrangement, the clothes are washed, dehydrated and dried in the same washing tub. Therefore, the washing machine with the clothes drying function has a reduced outer size, while providing higher deodorization and sterilization effects and permitting easy replacement of an ozone generation element and highly safe ozone handling.

According to an inventive aspect of claim 11, there is provided a washing machine which comprises: a treatment tub in which clothes are contained and the contained clothes are washed and dehydrated; an ozone generator which generates ozone; and an ozone supply controller which supplies the ozone generated by the ozone generator into the treatment tub; wherein the ozone supply controller supplies the ozone generated by the ozone generator into the treatment tub during a dehydrating step performed to dehydrate the clothes.

With this arrangement, the ozone is supplied into the treatment tub during the dehydrating step after the washing of the clothes. Thus, the ozone is applied to the clothes adhering to an inner peripheral wall of the treatment tub during the dehydrating step. Therefore, the clothes deodorization and sterilization effects can be improved.

According to an inventive aspect of claim 12, the washing machine of claim 11 is characterized in that the treatment tub includes a rotary drum to be rotated about a rotation axis, wherein the ozone supply controller supplies the ozone generated by the ozone generator into the treatment tub after a rotation speed of the rotary drum reaches a predetermined dehydration rotation speed.

With this arrangement, the ozone is supplied into the treatment tub after the rotation speed of the rotary drum reaches the predetermined rotation speed at which excess water is substantially removed from the clothes. Therefore, the water does not interfere with the ozone, so that the clothes deodorization and sterilization effects can be improved.

According to an inventive aspect of claim 13, the washing machine of claim 12 further comprises an agitator which agitates the clothes, wherein the ozone supply controller supplies the ozone into the treatment tub after the dehydrating step while causing the agitator to agitate the clothes.

With this arrangement, the clothes are agitated by the agitator (baffles, a pulsator or the like), so that the ozone can be evenly applied to the clothes. Further, the ozone is supplied to the dehydrated clothes. Therefore, the amount of excess water which may interfere with the supply of the ozone is reduced, so that the deodorization and sterilization effects of the ozone are improved.

According to an inventive aspect of claim 14, there is provided a washing machine which comprises: a treatment tub in which clothes are contained, and the contained clothes are washed and dehydrated; an ozone generator which generates ozone; and an ozone supply controller which supplies the ozone generated by the ozone generator into the treatment tub; the washing machine being configured to perform a laundering operation which is terminated after the dehydration of the clothes; wherein the ozone supply controller supplies the ozone generated by the ozone generator into the treatment tub after the dehydration of the clothes in the laundering operation.

With this arrangement, the clothes deodorization and sterilization effects are improved, where the laundering operation is completed after the dehydration of the clothes. Particularly, where bath water or the like is employed for a washing and/or a rinsing before the dehydration, odorants and bacteria contained in the bath water are prevented from adhering to the clothes.

According to an inventive aspect of claim 15, the washing machine of any one of claims 11 to 14 further comprises: an air duct having opposite ends and configured to feed air supplied from one of the opposite ends into the treatment tub, the other end being connected to the treatment tub; an air blowing unit provided in the air duct and configured to generate an air stream for feeding the air supplied from the one end into the treatment tub through the other end; and a heating unit provided in the air duct for heating air flowing through the air duct; wherein the ozone generator is connected to the air duct; wherein the ozone supply controller supplies the ozone together with the heated air flowing through the air duct into the treatment tub by actuating the air blowing unit and the heating unit during the supply of the ozone.

With this arrangement, the air blowing unit and the heating unit are used in combination during the ozone supply. Thus, air containing ozone activated by the heating is supplied into the treatment tub to apply the ozone to the clothes. This improves the clothes deodorization and sterilization effects. The air duct is preferably configured such that the air in the treatment tub is circulated through the air duct with not only the other end but also the one end of the air duct being connected to the treatment tub.

According to an inventive aspect of claim 16, there is provided a washing machine with a clothes drying function, which comprises: a treatment tub in which water is contained, and a washing process, a dehydrating process and a drying process are performed with clothes being contained therein; a drying air duct having opposite ends and configured to feed air supplied from one of the opposite ends into the treatment tub, the other end being connected to the treatment tub; an air blowing unit provided in the drying air duct and configured to generate an air stream for feeding the air supplied from the one end into the treatment tub through the other end; a heating unit provided in the drying air duct for heating air flowing through the drying air duct; an ozone generator disposed outside the drying air duct for generating ozone; an ozone supply controller which supplies the ozone generated by the ozone generator into the treatment tub through the drying air duct; and a selector which selects one of a washing course in which the washing process and the dehydrating process are performed, a washing/drying course in which the washing process, the dehydrating process and the drying process are performed, and a drying course in which the drying process is performed; wherein the ozone supply controller supplies the ozone into the treatment tub during the dehydrating step to dehydrate the clothes and/or after the dehydrating step if the washing course is selected, and supplies the ozone into the treatment tub during the drying operation if the washing/drying course or the drying course is selected.

With this arrangement, a control operation is performed so as to supply the ozone into the treatment tub at optimum timing depending on a course selected by a user. Therefore, the clothes are effectively deodorized and sterilized by the ozone without the need for the user to determine whether the ozone is to be supplied into the treatment tub. The drying operation includes a drying step of drying the clothes, and a cooling step of reducing the temperature of the clothes heated in the drying step. The drying air duct is preferably configured such that the air in the treatment tub is circulated through the drying air duct with not only the other end but also the one end of the drying air duct being connected to the treatment tub.

According to an inventive aspect of claim 17, there is provided a washing machine which comprises: a treatment tub in which clothes are contained, and the contained clothes are washed; an ozone generator which generates ozone; and an ozone supply controller which supplies the ozone generated by the ozone generator into the treatment tub; wherein the ozone supply controller supplies the ozone generated by the ozone generator into the treatment tub before water is supplied in a washing step.

With this arrangement, the ozone is applied to dry clothes before the washing step and, therefore, efficiently infiltrates into the clothes. Bacteria adhering to the clothes are oxidized by the ozone to be decomposed into more water-soluble substances, which can be easily removed from the clothes by washing the clothes in the washing step. Thus, a cleaning effect is improved. Further, the deodorization and sterilization effects are also improved.

According to an inventive aspect of claim 18, the washing machine of claim 17 further comprises a heating unit which heats an inside of the treatment tub before and/or during the supply of the ozone by the ozone supply controller.

With this arrangement, the dry clothes in the treatment tub are heated to a high temperature by the heating unit, so that the deodorization and sterilization effects of the ozone are further improved. Particularly, the high temperature promotes the deodorization effect.

According to an inventive aspect of claim 19, the washing machine of claim 17 or 18 further comprises a load detecting unit which detects an amount of the clothes contained in the treatment tub, wherein the ozone supply controller supplies the ozone into the treatment tub only when the load detected by the load detecting unit is greater than a predetermined level.

With this arrangement, the ozone supply controller does not supply the ozone if the load detected by the load detecting unit is not greater than the predetermined level. This prevents an increase in the concentration of unreacted ozone, thereby permitting safe control of the ozone.

According to an inventive aspect of claim 20, the washing machine of any one of claims 17 to 19 is characterized in that in response to a detergent-free washing signal applied to the washing machine, the ozone supply controller performs a detergent-free washing course in which the ozone is supplied into the treatment tub and subsequently to the supply of the ozone the clothes contained in the treatment tub are washed without a detergent and then rinsed.

With this arrangement, the ozone is applied to the dry clothes before the washing step, thereby improving the cleaning, deodorization and sterilization effects as in the inventive aspect of claim 17. Since the washing step is performed without the detergent, water used for the washing step and drained out of the machine is environmentally friendly. The detergent-free washing course is effective for daily washing of less dirty clothes such as towels and underwear.

### BRIEF DESCRIPTION OF THE DRAWINGS

FIG. 1 is a side vertical sectional view schematically showing the construction of an electric washing machine according to a first embodiment of the present invention.

FIG. 2 illustrates a modification of an ozone generator shown in FIG. 1.

FIG. 3 is a block diagram showing a control arrangement related to the present invention for the washing machine shown in FIG. 1 or 2.

FIG. 4 is a flow chart for explaining a control operation to be performed by a control section shown in FIG. 3 during supply of ozone before a washing step.

FIG. 5 is a flow chart for explaining a control operation to be performed by the control section shown in FIG. 3 during supply of ozone in a drying step.

FIG. 6 is a graph showing the states of components (plotted as ordinate) varying with time (plotted as abscissa), particularly, a part (a) showing the temperature of an outlet 16, a part (b) showing the operation state of a heater 21, a part (c) showing the rotation state of a blower 20, and a part (d) showing the state of ozone supply to a drum 3.

FIG. 7 is a perspective view of a washing machine according to a second embodiment of the present invention as obliquely seen from an upper front right side.

FIG. 8 is a schematic side sectional view of the washing machine of the second embodiment of the invention taken along an anteroposterior vertical plane as seen from a lateral side.

FIG. 9 is a block diagram showing a control arrangement related to the present invention for the washing machine 101 shown in FIGS. 7 and 8.

FIG. 10 is a plan view of a specific example of an operation panel 171 shown in FIG. 9.

FIG. 11 is a timing chart for explaining a clothes sterilizing process to be performed with the use of ozone in a drying operation.

FIG. 12 is a timing chart for explaining a clothes sterilizing process to be performed with the use of ozone in a final dehydrating operation.

FIG. 13 is a flow chart for explaining a modification of the clothes sterilizing process of FIG. 12 to be performed with the use of ozone in the final dehydrating operation.

FIG. 14 is a flow chart of an ozone cleaning step.

### DESCRIPTION OF REFERENCE CHARACTERS

1: Washing machine
3: Drum
13: Temperature sensor
15: Drying air duct
16: Outlet
17: Inlet
18: Dehumidification pipe
20: Blower
21: Heater
40: Ozone generator
51: Control section
101: Washing machine
103: Drum
116: Drying air duct
117: Outlet
118: Inlet
119: Dehumidification pipe
121: Blower
122: Heater
147: Ozone generator
161: Control section
171: Operation panel

### BEST MODE FOR CARRYING OUT THE INVENTION

### First Embodiment

A specific embodiment of the present invention will hereinafter be described with reference to the attached drawings.

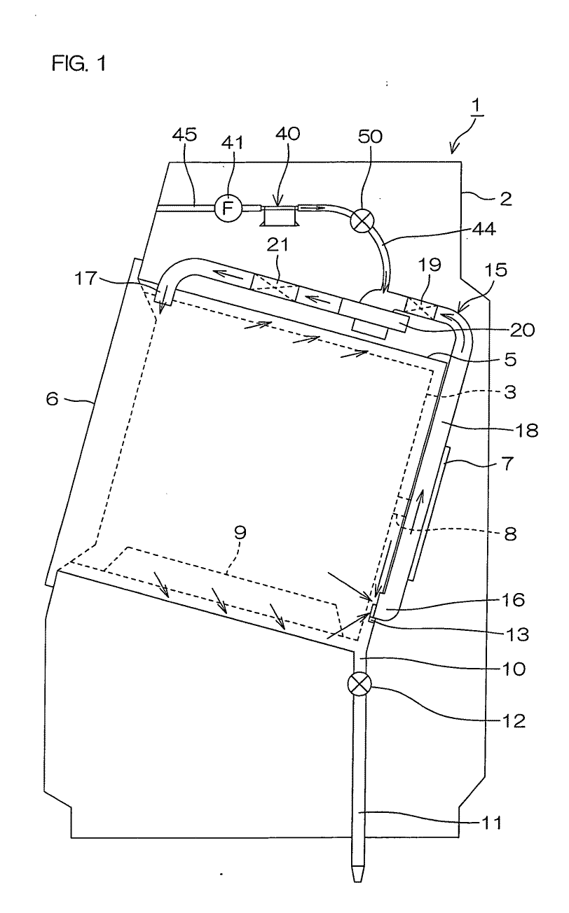

FIG. 1 is a side vertical sectional view schematically showing the construction of an electric washing machine according to a first embodiment of the present invention. The washing machine 1 according to this embodiment includes a housing 2 which defines its outer shell. A drum 3 serving as a treatment tub is disposed in a center portion of the housing 2.

The drum 3 has a hollow cylindrical shape, and is accommodated in a hollow cylindrical outer tub 5 coaxially with the outer tub 5. In this embodiment, the drum 3 and the outer tub 5 serve as a washing tub (treatment tub) having a so-called tilted drum structure in which the drum 3 has a front portion directed obliquely upward. The drum 3 and the outer tub 5 each have an open front end, and a door 6 is provided on a front face of the housing 2 for covering the open front end. A motor 7 is provided behind a rear end face of the outer tub 5, and the drum 3 is rotated about a rotation shaft 8 by the motor 7.

A washing process and a dehydrating process will be described specifically. In the washing process, water is contained in the outer tub 5. The outer tub 5 has an air- and liquid-tight structure, while the drum 3 has a multiplicity of perforations formed in a circumferential wall thereof. Therefore, when the water is contained in the outer tub 5, the water enters the drum 3 and hence is contained in the drum 3 for washing. Baffles 9 are provided at proper positions on an inner peripheral surface of the drum 3 as projecting from the inner peripheral surface. Clothes to be laundered are loaded into the drum 3 from a front side of the housing 2 with the door 6 being open. After the door 6 is closed, the drum 3 is rotated by the motor 7, whereby clothes soaked with the water in the drum 3 are lifted by the baffles 9 and naturally fall. Thus, a so-called beat-washing operation is performed.

A drain port 10 is provided in a lowermost portion, i.e., a lower portion of the rear end face, of the outer tub 5. The drain port 10 is connected to a drain pipe 11 which extends to the outside of the housing 2. A drain valve 12 is provided in the drain pipe 11. When the drain valve 12 is opened, the water contained in the outer tub 5 is drained out of the housing 2.

After the water is drained from the outer tub 5, the drum 3 is rotated (at a higher speed) for dehydration by the motor 7, whereby the water is removed from the clothes.

The washing machine 1 is capable of performing a drying process in addition to the washing process and the dehydrating process. Therefore, an outlet 16 of a drying air duct 15 is connected to a lower portion of the rear end face of the outer tub 5. A temperature sensor 13 is provided in the outlet 16 as dryness detecting unit for measuring a temperature at the outlet 16. The drying air duct 15 extends obliquely upward along the rear end face of the outer tub 5, then is bent forward along an upper portion of the outer tub 5, and further extends forward along an upper peripheral portion of the outer tub 5. The drying air duct 15 has an inlet 17 provided at its distal end and connected to a front peripheral portion of the outer tub 5. A portion of the drying air duct 15 extending obliquely upward along the rear end face of the outer tub 5 serves as a dehumidification pipe 18 (dehumidifying unit). High-temperature and high-humidity air flows out of the drum 3 from the outlet 16, and flows upward through the dehumidification pipe 18. At this time, water is dripped from a water pipe not shown in the dehumidification pipe 18. The high-temperature and high-humidity air is heat-exchanged with the water, whereby the high-temperature and high humidity air is cooled and dehumidified. The water from the water pipe and water condensed by the dehumidification fall down in the dehumidification pipe 18 to reach the drain port 10 through the outlet 16, and is drained out of the housing 2 when the drain valve 12 is opened.

A filter 19 is provided downstream of the dehumidification pipe 18 with respect to an air flowing direction in the drying air duct 15, and a blower 20 is provided as air blowing unit further downstream of the filter 19. With the blower 20 being rotated, the air in the drum 3 flows out from the outlet 16 and then through the drying air duct 15 to be supplied again into the drum 3 from the inlet 17. A heater 21 is provided as heating unit downstream of the blower 20 in the drying air duct 15. The air flowing through the drying air duct 15 is dehumidified in the dehumidification pipe 18, then heated by the heater 21, and supplied into the drum 3 from the inlet 17. Thus, the air in the drum 3 and the outer tub 5 is circulated through the drying air duct 15, whereby air containing moisture removed from the clothes is prevented from being expelled from the washing machine. Further, the air flowing through the drying air duct 15 is dehumidified in the dehumidification pipe 18, so that the air can be reused for drying.

An ozone generator 40 is provided above the outer tub 5 in the housing 2. The ozone generator 40 generates ozone by applying silent discharge to air introduced into the ozone generator through a filter 41 from an air flow passage 45 having an open end exposed in an outer front surface of the housing 2. Air passing through the ozone generator 40 contains ozone.

The air containing the ozone generated by the ozone generator 40 is supplied into the drying air duct 15 through a supply passage 44. A position at which the ozone-containing air is supplied is located downstream of the filter 19 and upstream of the blower 20 (on a suction side of the blower 20) in the drying air duct 15. With the blower 20 being rotated, a negative pressure is generated on the suction side, and the ozone-containing air is sucked into the blower 20 through the supply passage 44. Then, the ozone is mixed in the air circulated through the drying air duct 15, and the resulting mixture is supplied into the drum 3 through the inlet 17. Thus, the ozone generator 40 has a simplified mechanism without the need for providing a special device such as an air pump for ejecting the generated ozone. A valve 50 is provided in the supply passage 44 for controlling the passage of the ozone-containing air. When the clothes are dried in the drum 3, the air is circulated through the drying air duct 15. Therefore, the ozone is supplied to the clothes being dried, whereby odorants and bacteria adhering to the clothes are oxidized by the supplied ozone. Thus, the clothes are deodorized and sterilized. As the dryness of the clothes supplied with the ozone is increased, infiltration of the ozone into the clothes is promoted to improve deodorization and sterilization effects. Further, the air to be supplied into the drum 3 is heated by the heater 21, whereby the temperature of the clothes is increased to further improve the clothes deodorization and sterilization effects of the ozone. Particularly, the deodorization effect is further improved at a higher temperature. During the deodorization and the sterilization of the clothes with the ozone, the drum 3 is constantly rotated. The rotation of the drum 3 generates air streams in the outer tub 5. The air streams cause the air to flow through the drying air duct 15 via the inlet 17 of the drying air duct 15 communicating with the outer tub 5 in which the drum 3 is disposed. Therefore, the ozone is more effectively supplied into the drum 3. Since the clothes are agitated by the rotation of the drum 3, the ozone is evenly applied to the clothes. As a result, the deodorization and the sterilization of the clothes are promoted. Further, the ozone generator 40 is disposed above the outer tub 5 away from the drying air duct 15, permitting easy replacement of an ozone generation element which generates the ozone by the silent discharge.

Since the outer tub 5 in which the drum 3 is accommodated is liquid- and air-tight, the ozone generated by the ozone generator 40 is prevented from leaking out of the housing 2. Therefore, the washing machine 1 is safe and trouble-free in use without a waft of an ozone odor to the outside.

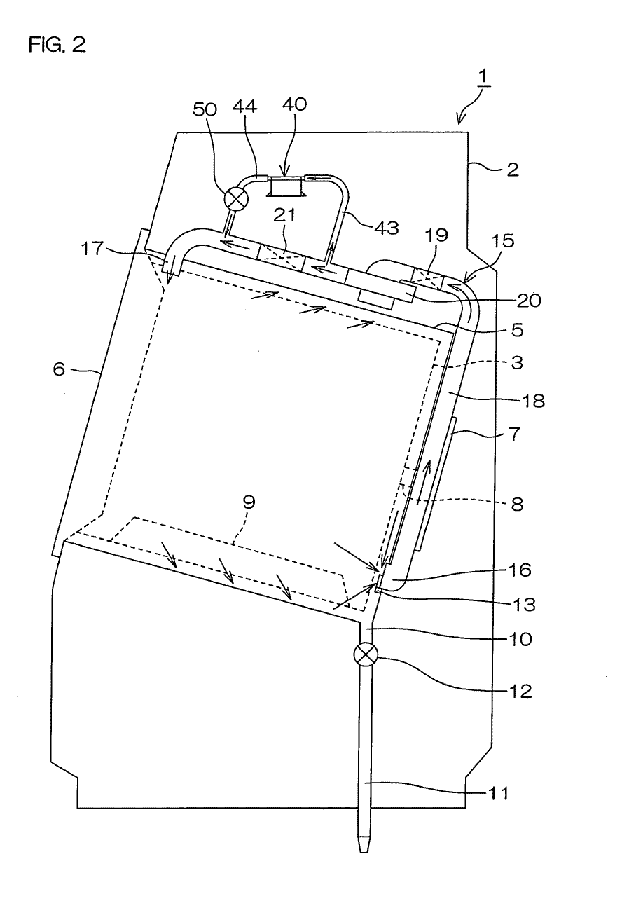

A modification of the ozone generator 40 is shown in FIG. 2. In FIG. 2, components similar to those described above will be denoted by the same reference characters, and will not be explained.

The ozone generator 40 serves as a bypass of the drying air duct 15. A suction passage 43 is connected to an upstream side of the ozone generator 40, while the supply passage 44 is connected to a downstream side of the ozone generator 40. The suction passage 43 has opposite ends, one of which is connected to the ozone generator 40 and the other of which is connected to a portion of the drying air duct 15 downstream of the blower 20 (on an ejection side of the blower 20) and upstream of the heater 21. The supply passage 44 has opposite ends, one of which is connected to the ozone generator 40 and the other of which is connected to a portion of the drying air duct 15 downstream of the heater 21 and upstream of the inlet 17.

Therefore, a part of the air circulated through the drying air duct 15 and ejected downstream of the blower 20 by the rotation of the blower 20 is forced to flow through the ozone generator 40 from the suction passage 43 by the momentum of the ejection, and subjected to the silent discharge to generate ozone. The air containing the ozone generated by the ozone generator 40 is forced to flow into the drying air duct 15 through the supply passage 44 by the air continuously flowing from an upstream side, and supplied together with the air heated by the heater 21 into the drum 3 through the inlet 17.

Thus, the ozone generator 40 has a simplified mechanism without the need for introducing air from the outside of the washing machine 1 for the generation of the ozone and without the need for providing a special device for supplying the generated ozone into the drying air duct 15. The ozone generator 40 is disposed above the outer tub 5 away from the drying air duct 15, permitting easy replacement of the ozone generation element which generates the ozone by the silent discharge.

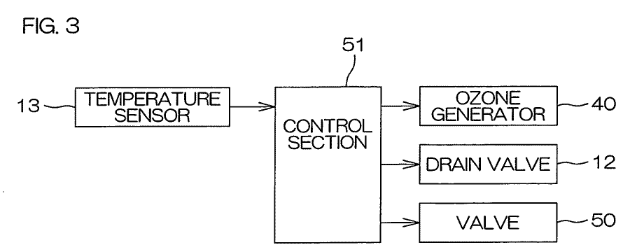

FIG. 3 is a block diagram showing the configuration of a control circuit of the washing machine shown in FIG. 1 or 2, illustrating only components related to the control of the ozone supply.

The washing machine 1 includes a control section 51 serving as ozone supply controller including, for example, a microcomputer and the like. The control section 51 controls the operation of the ozone generator 40, and the switching of the drain valve 12 and the valve 50. The control section 51 performs an ozone supply controlling operation according to the temperature detected at the outlet 16 by the temperature sensor 13.

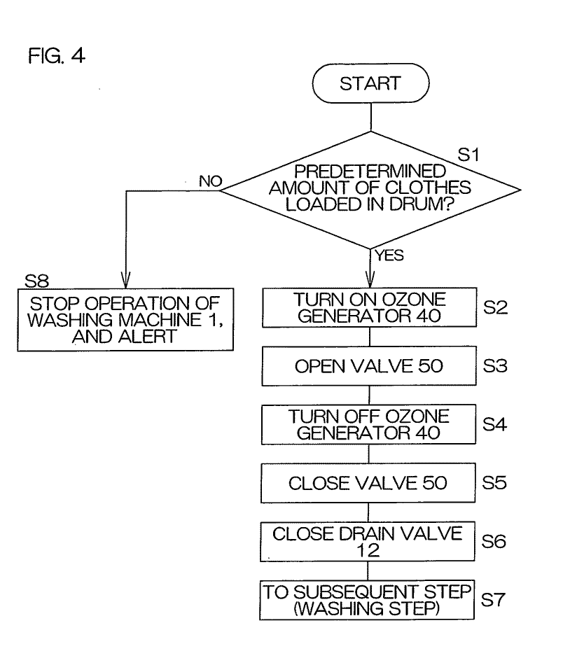

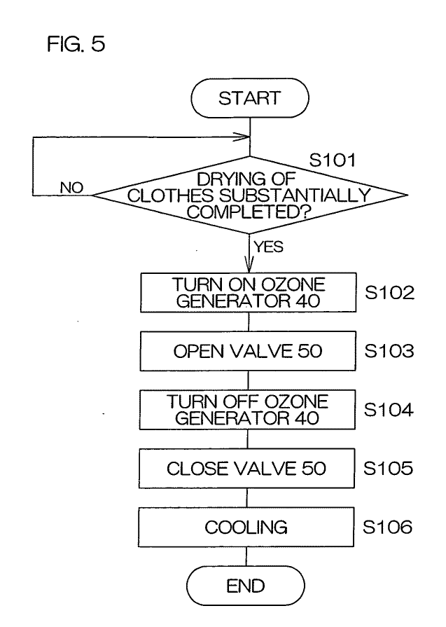

FIGS. 4 and 5 are flow charts for explaining control operations to be performed by the control section 51 shown in FIG. 3. A clothes deodorization and sterilization process to be performed with the use of the ozone by the washing machine 1 shown in FIG. 1 or 2 will be described with reference to the flow charts of FIGS. 4 and 5.

The washing machine 1 shown in FIG. 1 or 2 performs a washing step, a dehydrating step, a first rinsing step, another dehydrating step, a second rinsing step, further another dehydrating step and a drying step in this order for washing and dehydrating the clothes. In the first embodiment, the drying step is equivalent to a drying operation. As described above, what is important in the present invention is to supply the ozone to dry clothes for improvement of the clothes deodorization and sterilization effects. Therefore, it is desirable to supply the ozone to the clothes when the clothes are dry before the washing step or during the drying step. Where the ozone is supplied before the washing step, dirt adhering to the clothes is decomposed by the ozone, so that the cleaning effect is also improved. The ozone may be supplied either before the washing step or during the drying step, or both before the washing step and during the drying step. The deodorization and the sterilization of the clothes are promoted, as an ozone supply period is increased.

Where the washing process is completed by execution the washing step, the dehydrating step, the first rinsing step and the another dehydrating step, or the second rinsing step and the further another dehydrating step, the clothes deodorization and sterilization effects are improved by supplying the ozone to the dehydrated clothes. Particularly, where bath water is employed in the washing step and the rinsing step before the dehydrating step, odorants and bacteria contained in the bath water are prevented from adhering to the clothes.

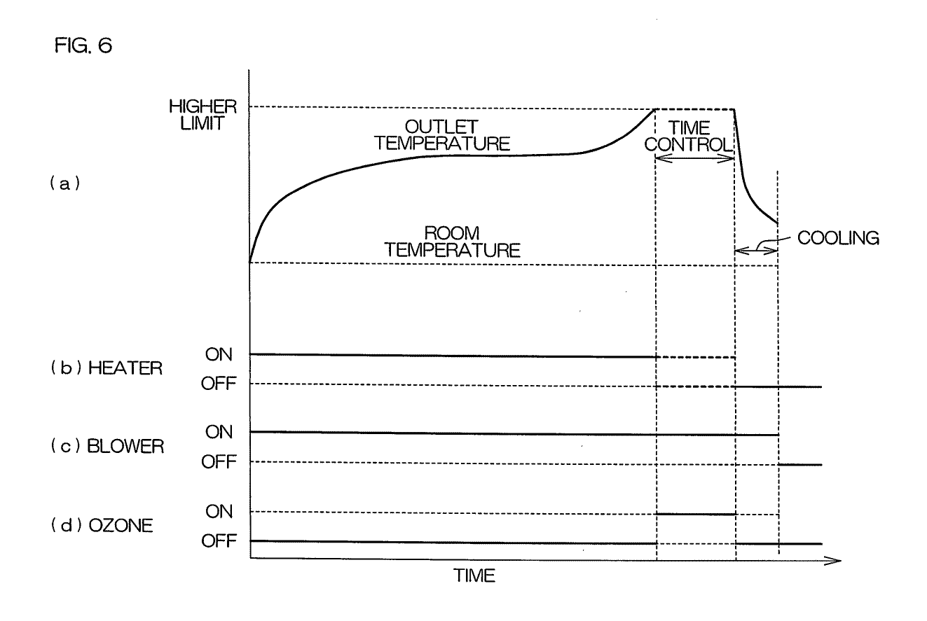

The ozone supply before the washing step will hereinafter be described with reference to the flow chart shown in FIG. 4. Further, the ozone supply during the drying step will be described with reference to the flow chart of FIG. 5 and a graph of FIG. 6 which shows changes in the operation states of the heater 21 and the blower 20, the temperature at the outlet 16 and the state of the ozone supply over time.

In FIG. 4, the control section 51 shown in FIG. 3 doubles as load detecting unit. After the door 6 is locked in a closed state, the control section 51 rotates the drum 3 at a certain rotation speed (e.g., 65 rpm) with predetermined electric power being applied to the drum 3, and then increases the rotation speed, for example, to 140 rpm with the electric power kept constant, whereby the clothes adhere to the inner peripheral surface of the drum 3. Then, a load exerted on the drum 3, i.e., the amount of the clothes contained in the drum 3, is determined based on the time required for the rotation speed to increase from 65 rpm to 140 rpm as measured by a timer not shown (Step S1). If the amount of the clothes contained in the drum 3 is greater than a predetermined amount (YES in Step S1), the rotation of the drum 3 is stopped, and then the ozone generator 40 is actuated (Step S2). Then, the rotation of the drum 3 is restarted, and the heater 21 is turned on. Further, the blower 20 is rotated, and the valve 50 is opened (Step S3). Thus, air containing ozone generated by the ozone generator 40 is supplied into the drying air duct 15 through the supply passage 44, and applied to the clothes in the drum 3 from the inlet 17. Thus, the clothes are deodorized and sterilized, and cleaned by decomposition of dirt. Since the door 6 is locked to be prevented from being inadvertently opened, there is no fear that the ozone supplied into the drum 3 leaks. The control section 51 continuously rotates the drum 3 during the ozone supply to the drum 3, so that the ozone is evenly applied to the clothes being agitated. Thus, the deodorization and the sterilization of the clothes are promoted. After the ozone is supplied into the drum 3 for a predetermined period (e.g., 10 minutes), the control section 51 stops the operation of the ozone generator 40 (Step S4), closes the valve 50 (step S5), turns off the heater 21, and stops the rotation of the blower 20 and the drum 3. The drain valve 12 may be open before the washing step. When the washing step is to be started, however, the drain valve 12 is closed (Step S6) because water should be contained in the outer tub 5 in the washing step. Thereafter, the washing step is performed (Step S7), and the dehydrating step, the first rinsing step, the dehydrating step and the second rinsing step are subsequently performed in this order.

On the other hand, if the amount of the clothes contained in the drum 3 is not greater than the predetermined amount (NO in Step S1), the control section 51 stops the operation of the washing machine 1, and calls user's attention to prompt the user to load clothes in an amount greater than the predetermined amount in the drum 3 (Step S8). The valve 50 is kept closed. If the ozone were supplied into the drum 3 with the ozone generator 40 actuated and with the valve 50 being open, a part of the ozone unreacted with odorants and bacteria adhering to the clothes would remain in the drum 3. Then, continuous supply of the ozone to the drum 3 would increase the concentration of the unreacted ozone. Therefore, if the amount of the clothes contained in the drum 3 is not greater than the predetermined amount, the ozone is not generated. This eliminates the possibility that the ozone concentration is increased. Thus, the control section 51 safely controls the ozone in the washing machine 1.

After the second rinsing step, the dehydrating step is performed, and then the control section 51 shown in FIG. 3 turns on the heater 21 and rotates the blower 20 and the drum 3 to start the drying step for drying the clothes in the drum 3.

After the start of the drying step, the control section 51 constantly monitors the temperature measured at the outlet 16 by the temperature sensor 13 over time as shown in FIG. 6(a). The temperature at the outlet 16 is the temperature of air which passes through the outlet 16 after being heated by the heater 21, entering the drum 3 from the inlet 17 and absorbing moisture removed from the clothes. The control section 51 determines the dryness of the clothes on the basis of the temperature at the outlet 16. The drain valve 12 is constantly opened during a period from the start to the end of the drying step. Therefore, as described above, the water removed from the clothes and the water dripped from the water pipe fall through the dehumidification pipe 18 to reach the drain port 10 through the outlet 16, and are drained out of the housing 2 through the opened drain valve 12.

It is judged whether the clothes are substantially dried (e.g., the drying of the clothes is about 90% completed) (Step S101 in FIG. 5) based on whether the temperature at the outlet 16 reaches a predetermined temperature (higher limit) as shown in a part (a) of FIG. 6.

When the drying of the clothes is substantially completed (YES in Step S101), the heater 21 is turned on and off by the control section 51, as shown in FIG. 6, so that the temperature at the outlet 16 is maintained at the predetermined temperature for a predetermined period (varying depending on the amount of the clothes), e.g., 10 minutes, which is set by the timer not shown. Upon starting the control of the temperature at the outlet 16, the control section 51 locks the door 6 in the closed state (if the door is already locked, this step is skipped), actuates the ozone generator 40 (Step S102 in FIG. 5), and opens the valve 50 provided in the supply passage 44 (Step S103 in FIG. 5). Thus, the air containing the ozone generated by the ozone generator 40 is supplied into the drying air duct 15 through the supply passage 44 to be applied to the clothes in the drum 3 from the inlet 17. Thus, the clothes are deodorized and sterilized. The ozone is thus applied to the clothes when the drying of the clothes is substantially completed. Therefore, the ozone efficiently infiltrates into the clothes, thereby improving the clothes deodorization and sterilization effects. Since the door 6 is locked to be prevented from being inadvertently opened, there is no fear that the ozone supplied into the drum 3 leaks.

If NO in Step S101 in FIG. 5, the drying of the clothes is continued.

After the ozone is supplied into the drum 3 for the predetermined period, the operation of the ozone generator 40 is stopped (Step 104 in FIG. 5), and the valve 50 is closed (Step S105 in FIG. 5). Further, the heater 21 is turned off (see a part (b) of FIG. 6), and the supply of the ozone is stopped (see a part (d) of FIG. 6). As shown in a part (c) of FIG. 6, the rotation of the blower 20 and the drum 3 is continued to supply unheated air into the drum 3. Thus, a so-called cooling step is performed, for example, for 5 to 10 minutes to cool the clothes to a predetermined temperature (Step S106 in FIG. 5). During the cooling step, all the ozone present in the housing 2 including the drum 3 is consumed by an oxidation reaction, so that the ozone concentration is reduced to a level which exerts no influence on a human body. The door 6 is locked during a period from the start of the ozone supply into the drum 3 to the completion of the cooling step and, even after the cooling step, the door 6 is kept locked, for example, for about 20 minutes after the stop of the ozone supply. This prevents the door 6 from being inadvertently opened, and ensures safe control of the ozone without the possibility of the leak of the ozone. Thereafter, the rotation of the blower 20 and the drum 3 is stopped, and the drying step is completed. Therefore, the washing machine is safe without the waft of the ozone odor to the outside when the user opens the door 6 after the completion of the drying step. Further, the user can readily take out the clothes, because the clothes are cooled.

### Second Embodiment

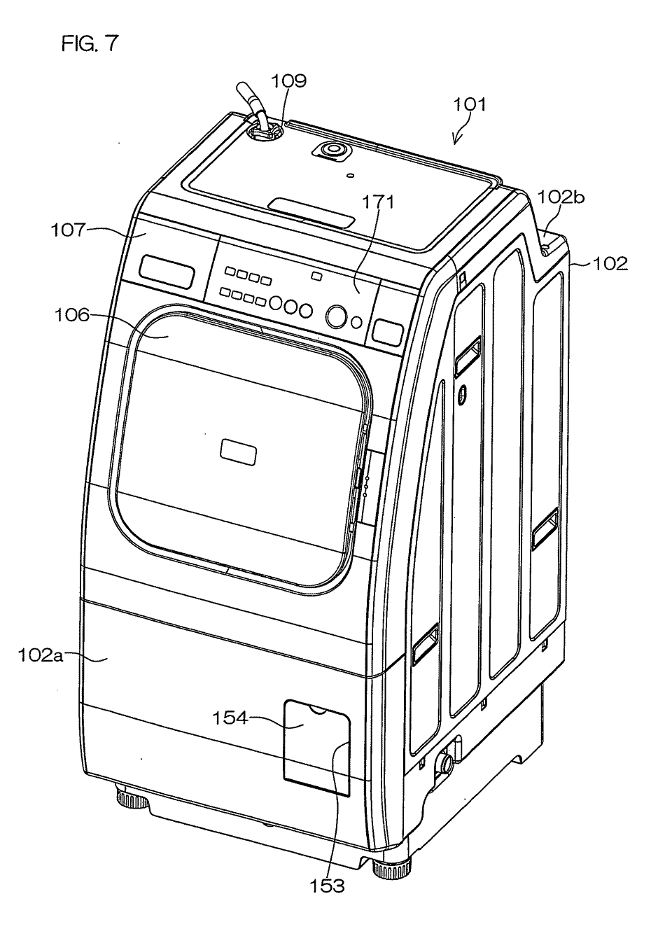

FIG. 7 is a perspective view of a washing machine according to a second embodiment of the present invention as obliquely seen from an upper front right side.

The washing machine 101 includes a generally vertically elongated housing 102 which defines its outer shell. A water supply port 109 is provided in a top face of the housing 102, and a water supply system such as a water line is connected to the water supply port 109. An operation panel 171 is provided on an upper portion of a front face of the housing 102. By operating the operation panel 171, the user causes the washing machine 101 to perform a desired operation.

A container portion 107 which can be pulled out for containing a detergent and a softener is provided on a left side of the operation panel 171.

The front face of the housing 102 has a lower portion extending vertically upward from a lower edge thereof, and a slightly inclined portion extending obliquely rearward from the lower portion. A door 106 is provided in a middle upper portion of the front face. The door 106 has a square shape having round corners as seen from the front side, and includes a round seal packing (not shown) provided on an inner portion thereof for closing an outer tub 5 to be described later.

An independently removable front panel 102a is provided in the lower portion of the front face of the housing 102. With the front panel 102a removed, a lower front portion of the washing machine 101 is exposed, permitting easy maintenance of a pump, a selector valve and a filter (to be described later) provided in the lower front portion of the washing machine 101.

A window 153 is provided in a right side portion of the front panel 102a, and covered with a cover 154. With the cover 154 removed, the filter (to be described later) is exposed, permitting easy removal of lint and the like trapped by the filter.

The housing 102 has a step 102b recessed downward in a rear top portion thereof. Since the housing 102 of the washing machine 101 has a relatively great height, there is a possibility that an upper portion of the housing 102 interferes with a faucet when the washing machine 101 is installed. Therefore, the recessed step 102b is provided in the rear top portion so as to permit proper installation of the washing machine 101 even if the faucet is located at a lower level.

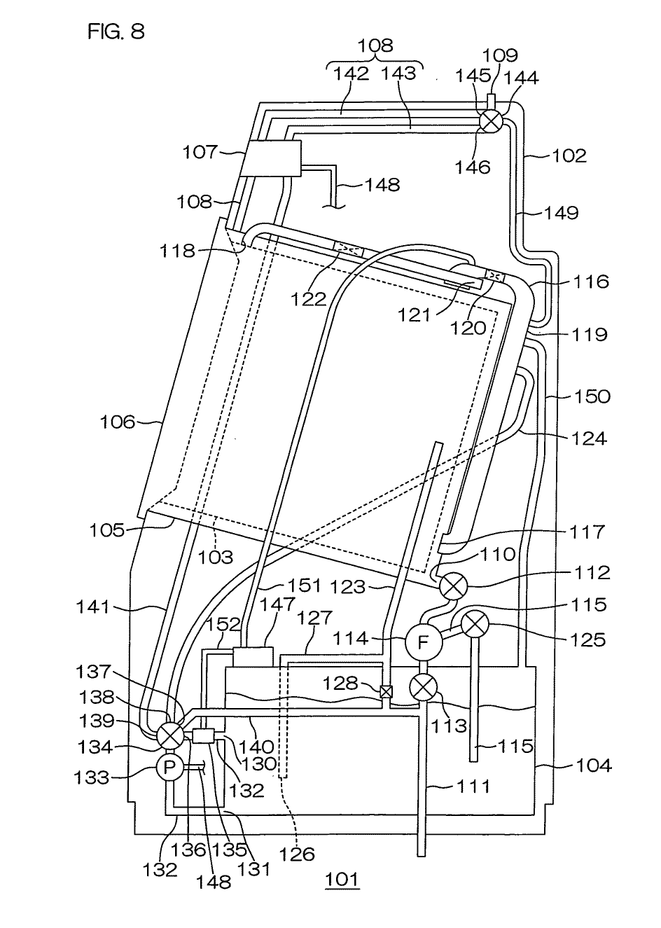

FIG. 8 is a schematic side sectional view of the washing machine of the second embodiment of the invention taken along an anteroposterior vertical plane as seen from a lateral side. In the following description of the washing machine 101 and elements (components) of the washing machine 101 according to this embodiment, the left side, the right side, the upper side and the lower side in FIG. 8 are defined as a front (forward) side, a rear (rearward) side, an upper (upward) side and a bottom (downward) side of the washing machine 101 for convenience.

A drum 103 is disposed in a middle portion of the housing 102.

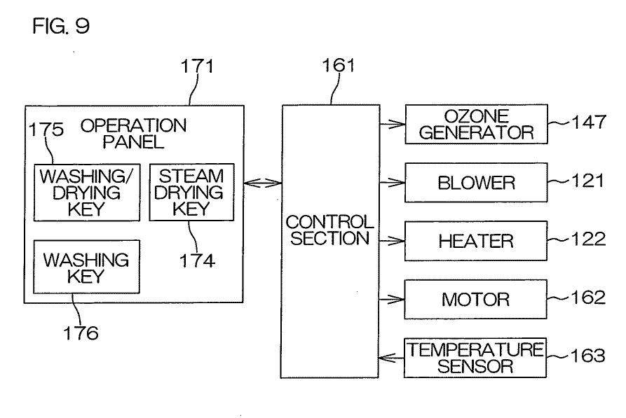

The drum 103 has a hollow cylindrical shape, and is accommodated in a hollow cylindrical outer tub 105 coaxially with the outer tub 105. In this embodiment, the drum 103 and the outer tub 105 serve as a washing tub (treatment tub) having a so-called tilted drum structure in which the drum 103 has a front portion directed obliquely upward. The drum 103 and the outer tub 105 each have an open front end, and the door 106 is provided on the front face of the housing 102 for covering the open front end. A motor 162 (not shown in FIG. 8 but shown in FIG. 9) is provided behind a rear end face of the outer tub 105, and the drum 103 is rotated about a center axis thereof by the motor.

A water supply pipe 108 provided in the housing 102 is connected to the water supply port 109 in the top face of the housing 102 via a first selector valve 144 (four-way valve). The water supply pipe 108 has opposite ends, one of which is connected to the water supply port 109 and the other of which is connected to an uppermost portion of a peripheral wall of the outer tub 105, whereby the water supply port 109 communicates with the outer tub 105 through the water supply pipe 108. The container portion 107 which contains the detergent and the softener is disposed in the midst of the water supply pipe 108.

The container portion 107 includes a box (not shown) which can be pulled out forward of the housing 102 and is partitioned into a detergent containing chamber and a softener containing chamber. With the box pulled out, the detergent and the softener are put in the respective containing chambers, and then the box is pushed in. Thus, the detergent and the softener are set. When water is supplied to the container portion 107 through the water supply pipe 108, the detergent and/or the softener respectively contained in the detergent containing chamber and the softener containing chamber are dissolved in the water supplied through the water supply pipe 108 to be supplied into the outer tub 105. It is also possible to selectively supply water containing neither or either of the detergent and the softener into the outer tub 105.

A priming pipe 148 is connected to a vertically middle portion of a rear face of the container portion 107 at its one end, and the other end of the priming pipe 148 is connected to a supply pump 133 provided in the housing 102. When the supply pump 133 is driven for pumping water in the housing 102, priming water is supplied into the supply pump 133 from the container portion 107.

The water supply pipe 108 is branched into a detergent water supply pipe 142 and a softener water supply pipe 143 at the first selector valve 144, and the detergent water supply pipe 142 and the softener water supply pipe 143 are combined together at the container portion 107.

The first selector valve 144 has an inlet through which the water flows in from the water supply port 109, a detergent water outlet 145 connected to the detergent water supply pipe 142, and a softener water outlet 146 connected to the softener water supply pipe 143.

Therefore, the water flowing into the first selector valve 144 through the inlet is selectively caused to flow into the detergent containing chamber of the container portion 107 from the detergent water outlet 145 through the detergent water supply pipe 142, or to flow into the softener containing chamber of the container portion 107 from the softener water outlet 146 through the softener water supply pipe 143.

A washing process and a dehydrating process will be described specifically. In a washing step, clothes to be laundered by the washing machine 101 are loaded into the drum 103 from a front side of the housing 102 with the door 106 being open. After the door 106 is closed, water is supplied into the outer tub 105. The outer tub 105 has an air- and liquid-tight structure, while the drum 103 has a multiplicity of perforations formed in a circumferential wall thereof. Therefore, when the water is contained in the outer tub 105, the water enters the drum 103 and hence is contained in the drum 3 for washing.

Baffles (not shown) serving as agitator are provided at proper positions on an inner peripheral surface of the drum 103 as projecting from the inner peripheral surface. When the drum 3 is rotated by the motor, clothes soaked with the water in the drum 103 are lifted by the baffles and naturally fall. Thus, a so-called beat-washing operation is performed. Upon completion of the washing step, the water is drained from the outer tub 105.

A drain port 110 is provided in a lowermost portion, i.e., a lower portion of the rear end face, of the outer tub 105 as opening rearward, and a drain valve 112 is attached to a rear side of the drain port 110. A drain pipe 111 is connected to the drain valve 112 and extends downward, and a filter 114 and a second selector valve 113 are provided in this order in the drain pipe 111. A branch pipe 115 separate from the drain pipe 111 is connected to the filter 114. By switching the second selector valve 113, water passing through the filter 114 is selectively caused to continuously flow through the drain pipe 111 to be drained out of the housing 102, or to flow into the branch pipe 115.

Since the drain port 110 opens rearward of the outer tub 105 and the drain valve 112 is disposed on the rear side of the drain port 110, the drain port 110 and the drain valve 112 are located at substantially the same level as the lowermost portion of the outer tub 105. Thus, a wider space for accommodating various components is provided below the outer tub 105, because the drain port 110 and the drain valve 112 do not protrude into the space. Particularly, during the operation of the washing machine 101, the outer tub 105 is vibrated, so that the drain port 110 and the drain valve 112 fixed to the outer tub 105 are vibrated together with the outer tub 105. If the drain port 110 and the drain valve 112 protrude downward from the outer tub 105, a sufficient space should be provided below the outer tub 105 in consideration of the vibration. In this embodiment, however, the drain port 110 and the drain valve 112 are disposed behind the outer tub 105, so that the space provided below the outer tub 105 can be advantageously utilized for installing other components.

With the drain valve 112 and the second selector valve 113 being open, the water in the outer tub 105 is drained out of the housing 102. On the other hand, with the drain valve 112 being open and with the second selector valve 113 being closed, the water in the outer tub 105 flows into the branch pipe 115 through the filter 114.

After the water in the outer tub 105 is drained, a rinsing step is performed. In the rinsing step, the drain valve 112 is closed again, and water is contained in the outer tub 105 as in the washing step. Then, the drum 103 is rotated by the motor, whereby the clothes are rinsed.

After completion of the rinsing step, the rotation of the drum 103 is stopped, and the water in the outer tub 105 is drained out of the housing 102 in the same manner as the aforementioned water draining operation.

In a dehydrating step, the drum 103 is rotated (at a higher speed) for dehydration by the motor, whereby the water is removed from the clothes. In the washing machine 101 according to this embodiment, the rotation speed of the drum 103 is gradually increased for the dehydration to prevent abnormal vibration of the drum 103 which may otherwise occur due to uneven distribution of the clothes on the inner peripheral wall of the drum 103 during the dehydration.

The washing machine 101 according to this embodiment performs the washing step, a first dehydrating step, a first rinsing step, a second dehydrating step, a second rinsing step, a final dehydrating step and a drying step in this order for washing, dehydrating and drying the clothes.

More specifically, an outlet 117 of a drying air duct 116 serving as an air duct is connected to a lower portion of the rear end face of the outer tub 105, so that the washing machine 101 can perform the drying process in addition to the washing and dehydrating processes. A temperature sensor 163 (not shown in FIG. 8 but shown in FIG. 9) for measuring a temperature at the outlet 117 is provided in the outlet 117. The drying air duct 116 extends obliquely upward along the rear end face of the outer tub 105, then is bent forward along an upper portion of the outer tub 105, and further extends forward along an upper peripheral portion of the outer tub 105. The drying air duct 116 has an inlet 118 provided at its distal end and connected to a front peripheral portion of the outer tub 105. A portion of the drying air duct 116 extending obliquely upward along the rear end face of the outer tub 105 serves as a dehumidification pipe 119 (dehumidifying unit).

A filter 120 is provided downstream of the dehumidification pipe 119 with respect to an air flowing direction in the drying air duct 116, and a blower 121 is provided as air blowing unit further downstream of the filter 120. With the blower 121 being rotated, the air in the drum 103 flows out into the drying air duct 116 through the outlet 117 to be supplied again into the drum 103 from the inlet 118. A heater 122 as heating unit is provided downstream of the blower 121 in the drying air duct 116. The air flowing through the drying air duct 116 is dehumidified in the dehumidification pipe 119, then heated by the heater 122, and supplied into the drum 103 from the inlet 118.

By applying the air heated by the heater 122 to the clothes, water contained in the clothes is evaporated into steam, and high-temperature and high-humidity air containing the steam in the drum 103 flows out from the outlet 117 and then upward through the dehumidification pipe 119. At this time, water supplied from a heat exchange water supply pipe 149 is dripped in the dehumidification pipe 119. More specifically, the heat exchange water supply pipe 149 is connected to the first selector valve 144 at its one end, and the other end of the heat exchange water supply pipe 149 is connected to an upper portion of the dehumidification pipe 119. Therefore, the water from the water supply port 109 is dripped in the dehumidification pipe 119 from the heat exchange water supply pipe 149 by switching the first selector valve 144. It is also possible to supply water into the dehumidification pipe 119 from a heat exchange tank water supply pipe 124 provided separately from the heat exchange water supply pipe 149. The configuration of the heat exchange tank water supply pipe 124 will be described later.

When the water is dripped in the dehumidification pipe 119, the high-temperature and high-humidity air is heat-exchanged with the water, whereby the high-temperature and high humidity air is cooled and dehumidified. The water from the heat exchange water supply pipe 149 or the heat exchange tank water supply pipe 124 and water condensed by the dehumidification fall down in the dehumidification pipe 119 to reach the drain port 110 through the outlet 117, and is drained out of the housing 102 when the drain valve 112 and the second selector valve 113 are opened.

A tank 104 is provided below the drum 103. The tank 104 is a sealed tank which stores water once used in the outer tub 105. For introducing the water into the tank 104 from the outer tub 105, the branch pipe 115 has opposite ends, one of which is connected to the filter 114 and the other of which is open in the tank 104. More specifically, a water storage valve 125 is provided in the branch pipe 115, and a portion of the branch pipe 115 defined between the filter 114 and the water storage valve 125 extends obliquely upward from the filter 114 toward the water storage valve 125. The branch pipe 115 further extends downward from the water storage valve 125 and then through a top face of the tank 104, and the other end of the branch pipe 115 is located at a vertically middle position in the tank 104.

Therefore, the water in the outer tub 105 is introduced into the tank 104 with the second selector valve 113 being closed and with the drain valve 112 and the water storage valve 125 being open.

A degassing hose 150 is connected to the tank 104 at its one end. The degassing hose 150 extends upward from the tank 104 behind the outer tub 105, and the other end of the degassing hose 150 is connected to an upper portion of the dehumidification pipe 119. Thus, the inside of the tank 104 communicates with the drying air duct 116.

The tank 104 is provided with a pressure regulating drain pipe 127 having an inlet 126 opening in the tank 104. A check valve 128 is provided in the pressure regulating drain pipe 127. An outlet of the pressure regulating drain pipe 127 is connected to a portion of the drain pipe 111 downstream of the second selector valve 113.

Further, an overflow pipe 123 is connected to the pressure regulating drain pipe 127. When water is supplied in an amount greater than a predetermined amount in the outer tub 105, an excess amount of the water overflows out of the outer tub 105 through the overflow pipe 123, and is drained out of the washing machine 101 through the drain pipe 111.

The tank 104 is provided with a circulation pipe 132 which permits communication between an outlet 131 and an inlet 130 provided on a lateral side of the tank 104 for circulating water stored in the tank 104. The supply pump 133, a third selector valve 134 and an ejector 135 are arranged in this order in a water circulating direction from the outlet 131 to the inlet 130 in the circulation pipe 132.

The third selector valve 134 is a five-way valve which includes a first outlet 136, a second outlet 137, a third outlet 138 and a fourth outlet 139 to cause water ejected therein from the supply pump 133 to selectively flow in one of four directions.

The first outlet 136 is connected to the circulation pipe 132 to communicate with the inlet 130 through the ejector 135.

The second outlet 137 is connected to a tank water drain pipe 140, which is connected to a portion of the pressure regulating drain pipe 127 downstream of the check valve 128.

The third outlet 138 is connected to one end of the heat exchange tank water supply pipe 124. The other end of the heat exchange tank water supply pipe 124 is connected to the upper portion of the dehumidification pipe 119.

The fourth outlet 139 is connected to one end of a tank water supply pipe 141. The other end of the tank water supply pipe 141 is connected to the water supply pipe 108 through the container portion 107.

An ozone generator 147 is provided in the vicinity of the tank 104. The ozone generator 147 generates ozone by applying silent discharge to air introduced from an air flow passage (not shown). Air passing through the ozone generator 147 contains the ozone.

In this embodiment, the air containing the ozone generated by the ozone generator 147 is supplied into the drying air duct 116 through a first supply passage 151. A position at which the ozone-containing air is supplied is located downstream of the filter 120 and upstream of the blower 121 (on a suction side of the blower 121) in the drying air duct 116. When the blower 121 is rotated, a negative pressure is generated on the suction side, so that the ozone-containing air is sucked into the blower 121 through the first supply passage 151. Therefore, the ozone generator 147 has a simplified mechanism without the need for providing a special device such as an air pump for ejecting the generated ozone. The ozone is mixed in the air circulated through the drying air duct 116 to be supplied into the drum 103 from the inlet 118.

In general, the air is circulated through the drying air duct 116 when the clothes are dried in the drum 103 in the drying unit. In the present invention, a control section 161 shown in FIG. 9 controls the motor 162 (see FIG. 9) for rotating the drum 103, and the ozone generator 147, the blower 121 and the heater 122 so as to supply the ozone into the drum 103 at optimum timing depending on an operation course in response to a course input signal applied when the user presses a key provided on the operation panel 171 shown in FIG. 9. This obviates the need for the user to determine whether the ozone is to be supplied into the drum 103, and ensures effective clothes deodorization and sterilization with the ozone.

Further, as shown in FIG. 8 the air containing the ozone generated by the ozone generator 147 is supplied into the ejector 135 through a second supply passage 152. The ozone supplied through the second supply passage 152 is mixed with the circulated water in the tank 104. More specifically, the ozone-containing air supplied from the second supply passage 152 is mixed in the form of fine bubbles with the water by a negative pressure generated in the ejector 135 when the water passes through the ejector 135. Coloring matter, odorants and bacteria, if contained in the water, are oxidized by the ozone, whereby the water in the tank 104 is decolorized, deodorized and sterilized.

The outer tub 105 in which the drum 103 is accommodated is liquid- and air-tight. Further, because the tank 104 is connected to the outer tub 105 through the overflow pipe 123 and the degassing hose 150 the ozone generated by the ozone generator 147 flows between the tank 104 and the outer tub 105, but does not leak out of the housing 102. Therefore, the washing machine 101 is safe and trouble-free in use without a waft of an ozone odor to the outside.

FIG. 9 is a block diagram showing the configuration of a control circuit of the washing machine 101 shown in FIGS. 7 and 8, illustrating only components related to ozone supply control according to the present invention.

The washing machine 101 includes the control section 161 as ozone supply controller, for example, constituted by a microcomputer and the like. The control section 161 is connected to the ozone generator 147, the blower 121, the heater 122 and the motor 162. Further, the operation panel 171 provided as the selector, for example, on the top face of the housing 102 is connected to the control section 161. Various indicators are disposed on the operation panel 171, and indications of the indicators are controlled by the control section 161. When the user operates a steam drying key 174, a washing/drying key 175 or a washing key 176 provided on the operation panel 171, a signal is inputted to the control section 161.

Further, the temperature sensor 163 for measuring the temperature at the outlet 117 (see FIG. 8) of the drying air duct is connected to the control section 161.

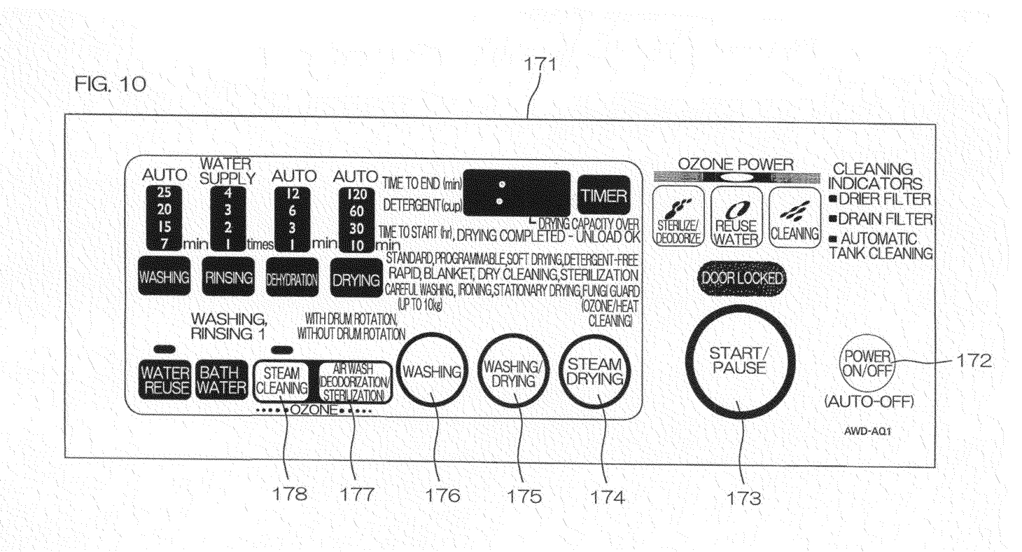

FIG. 10 is a plan view of a specific example of the operation panel 171.

A power on/off key 172 and a start/pause key 173 are provided on the operation panel 171. The power on/off key 172 is operated to turn on and off power supply to the washing machine 101. The start/pause key 173 is operated to start and pause the operation of the washing machine 101.

The steam drying key 174, the washing/drying key 175 and the washing key 176 are provided on the operation panel 171. The steam drying key 174 is pressed to select a drying course for performing only the clothes drying process. The washing/drying key 175 is pressed to select a washing/drying course for performing a process sequence from the washing process to the drying process. The washing key 176 is pressed to select a washing course for performing the washing process and the dehydrating process without performing the drying process.

When the washing key 176 is repeatedly pressed, for example, washing-related operation items are sequentially highlighted out of operation items listed in a 3×4 matrix. More specifically, when the washing key 176 is pressed once, “STANDARD” is lit. When the washing key 176 is pressed once again, “STANDARD” is unlit and “PROGRAMMABLE” is lit. When the washing key 176 is pressed further once again, “PROGRAMMABLE” is unlit and “DETERGENT-FREE” is lit. In this manner, the washing-related operation items are sequentially highlighted for selection.

Similarly, when the washing/drying key 175 or the steam drying key 174 is repeatedly pressed, washing/drying-related operation items or drying-related operation items are sequentially highlighted for selection.

Further, an air wash key (sterilization and deodorization) key 177 and a steam cleaning key 178 are provided on the operation panel 171.

The air wash (sterilization and deodorization) key 177 is operated when the clothes are to be deodorized without washing thereof. Where the clothes have the smell of tobacco, for example, the clothes are loaded into the drum 103, and the air wash (sterilization and deodorization) key 177 is pressed. Depending on the number of times of pressing the air wash (sterilization and deodorization) key 177, an indication provided on an upper side of the air wash key 177 is shifted in such a manner that “WITH DRUM ROTATION” is first lit, then “WITHOUT DRUM ROTATION” is lit, then both “WITH DRUM ROTATION” and “WITHOUT DRUM ROTATION” are unlit, and “WITH DRUM ROTATION” is lit. When “WITH DRUM ROTATION” is lit, the ozone-containing air is supplied into the drum 103 with the drum 103 being rotated. When “WITHOUT DRUM ROTATION” is lit, the ozone-containing air is supplied into the drum 103 with the drum 103 not rotated. In this manner, the clothes deodorizing process is performed independently of the washing process and the drying process. That is, the air wash (sterilization and deodorization) key 177 is operated when the deodorizing process is to be independently performed to deodorize the clothes which do not require the washing process.

The steam cleaning key 178 is pressed when a steam cleaning process is to be performed in addition to the washing process.

Although various keys and operation indicators other than the aforementioned ones are provided on the operation panel 171, these keys and indicators are not directly related to the present invention and therefore will not be explained.

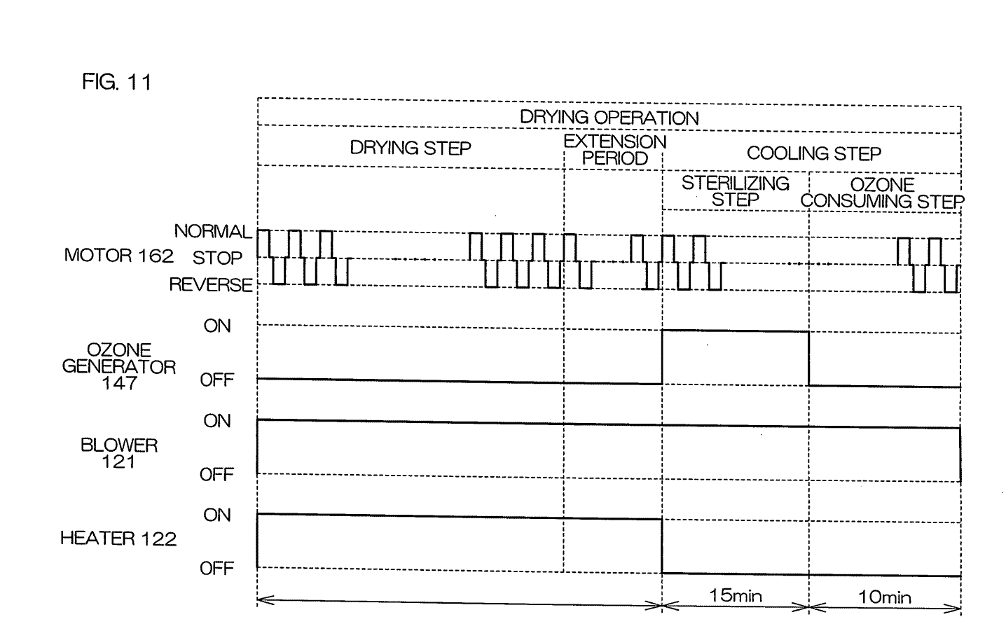

FIG. 11 is a timing chart for explaining a clothes sterilizing process to be performed with the use of the ozone in a drying operation. Where the control section 161 detects an input signal indicating that the washing/drying key 175 or the steam drying key 174 is selected, for example, the drying operation is performed in the following manner.

The drying operation includes the drying step, a drying step extension period and a cooling step, which occur in this order over time. The cooling step includes a sterilizing step to be performed in a first half period and an ozone consuming step to be performed in a second half period.

When the drying step is started, the control section 161 actuates the motor 162, and turns on the blower 121 and the heater 122. The motor 162 rotates the drum 103 at a predetermined rotation speed (e.g., 45 rpm) alternately in a normal direction and in a reverse direction, whereby the clothes are agitated. Thus, hot air can be evenly applied to the clothes, so that water contained in the clothes is evaporated.

The operation status of the drying step is determined based on the temperature at the outlet 117. When the temperature detected by the temperature sensor 163 reaches a predetermined temperature level, the control section 161 judges that the dryness reaches 92%, for example, and the drying step is continuously performed for a predetermined period from that time. The predetermined period in which the drying step is continued after the temperature reaches the predetermined temperature level as detected by the temperature sensor 163, is herein referred to as “drying step extension period.” When the extension period ends, the dryness of the clothes reaches 98 to 100%, for example.

After the drying step extension period, the control section 161 turns off the heater 122, and starts the cooling step to cool the clothes to a predetermined temperature level in the drum 103. When the cooling step is started, the control section 161 turns on the ozone generator 147.

Thus, the air containing the ozone generated by the ozone generator 147 is supplied into the drum 103.

Since the ozone is applied to clothes containing no excess water after the completion of the drying of the clothes, no water interferes with the ozone. Therefore, the ozone efficiently infiltrates into the clothes, whereby odorants remaining in the clothes are oxidized by the ozone to be thereby removed. Even if bacteria are still unremoved by the drying heat in the drying step, the bacteria are killed by the ozone. Further, the ozone can be evenly applied to the clothes, because the clothes are agitated by the rotation of the drum 103.

After the sterilizing step is performed for a predetermined period (e.g., 15 minutes) in the first half period of the cooling step, the control section 161 turns off the ozone generator 147. When the temperature measured by the temperature sensor 163, i.e., a temperature in the drum 103, is reduced to a predetermined temperature level (e.g., 50° C. or lower) by continuously performing the cooling step, the cooling step is terminated. Unless the ozone consuming step in the second half period of the cooling step is performed, for example, for 10 minutes, the cooling step is extended, even if the temperature in the drum 103 is reduced to 50° C. or lower. Thus, the ozone present in the housing 102 including the drum 103 is consumed by an oxidation reaction. This eliminates the possibility of the waft of the ozone odor when the user opens the door 106 to take the clothes out of the drum 103.

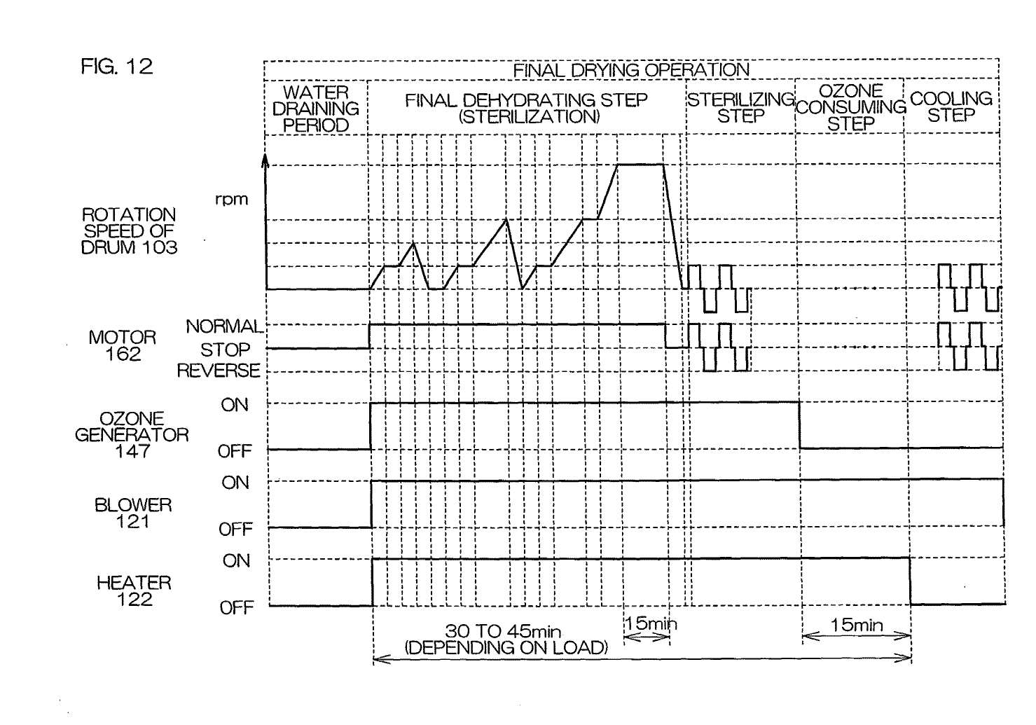

FIG. 12 is a timing chart for explaining a clothes sterilizing process to be performed with the use of the ozone in a final dehydrating operation. Where the control section 161 detects an input signal indicating that the washing key 176 is selected, the final dehydrating operation is performed in the following manner.

The final dehydrating operation includes a water draining period in which the water is drained from the outer tub 105, a final dehydrating step, a sterilizing step, an ozone consuming step and a cooling step, which occur in this order over time.

After a lapse of a water draining period (e.g., two to three minutes), the control section 161 actuates the motor 162 to rotate the drum 103, whereby the final dehydrating step is started to remove water contained in the clothes.

In this embodiment, the ozone generator 147 and the blower 121 are turned on at the start of the final dehydrating step to supply the ozone into the drum 103 during the final dehydrating step. Thus, the ozone is supplied to the clothes adhering to the inner peripheral wall of the drum 103 even during the dehydrating step, thereby improving the deodorization and sterilization effects. Further, the heater 122 is turned on, so that the ozone to be supplied is activated by the heat.

In the final dehydrating step, the rotation speed of the drum 103 is gradually increased at the beginning of the rotation of the drum 103 to prevent abnormal vibration of the drum 103 which may otherwise occur due to uneven distribution of the clothes on the inner peripheral wall of the drum 103. More specifically, the rotation speed of the drum 103 is increased up to a predetermined rotation speed, then kept at the predetermined rotation speed for a predetermined period, and reduced and, if necessary, the rotation of the drum 103 is stopped. The reduction in rotation speed and the stop of the rotation cause the clothes to fall from the inner peripheral wall of the drum 103, thereby suppressing the uneven distribution of the clothes when the rotation speed of the drum 103 is increased again. After this cycle is repeated, for example, twice or three times, the drum 103 is rotated at a final dehydration rotation speed (e.g., 900 rpm).

After the drum 103 is rotated at 900 rpm for 15 minutes, the control section 161 once stops the motor 162 to terminate the final dehydrating step.

After completion of the final dehydrating step, the sterilizing step, the ozone consuming step and the cooling step are performed. In the sterilizing step following the final dehydrating step, the control section 161 rotates the drum 103 alternately in the normal direction and in the reverse direction, and further supplies the ozone. The clothes are agitated by the baffles (not shown) in the sterilizing step, so that the ozone is evenly applied to the clothes. Since the ozone is supplied to the dehydrated clothes, the amount of excess water which may interfere with the ozone supply is reduced. This improves the deodorization and sterilization effects of the ozone.

After the ozone is supplied into the drum 103 for a predetermined period, the ozone generator 147 is turned off to terminate the sterilizing step, and then the ozone consuming step is performed.

After a lapse of 15 minutes from the start of the ozone consuming step, the heater 122 is turned off, and the cooling step is started. In the cooling step, the blower 121 is kept on, so that the air in the drum 103 is continuously circulated. The circulation of cooling air speedily reduces the temperature of the clothes. A period from the start of the final dehydrating step to the completion of the ozone consuming step is approximately 30 to 45 minutes, but varies depending on the load (the amount of the washed clothes).

In this embodiment, the heater 122 is turned off upon completion of the ozone consuming step, but may be turned off at the start of the ozone consuming step for skipping the cooling step.

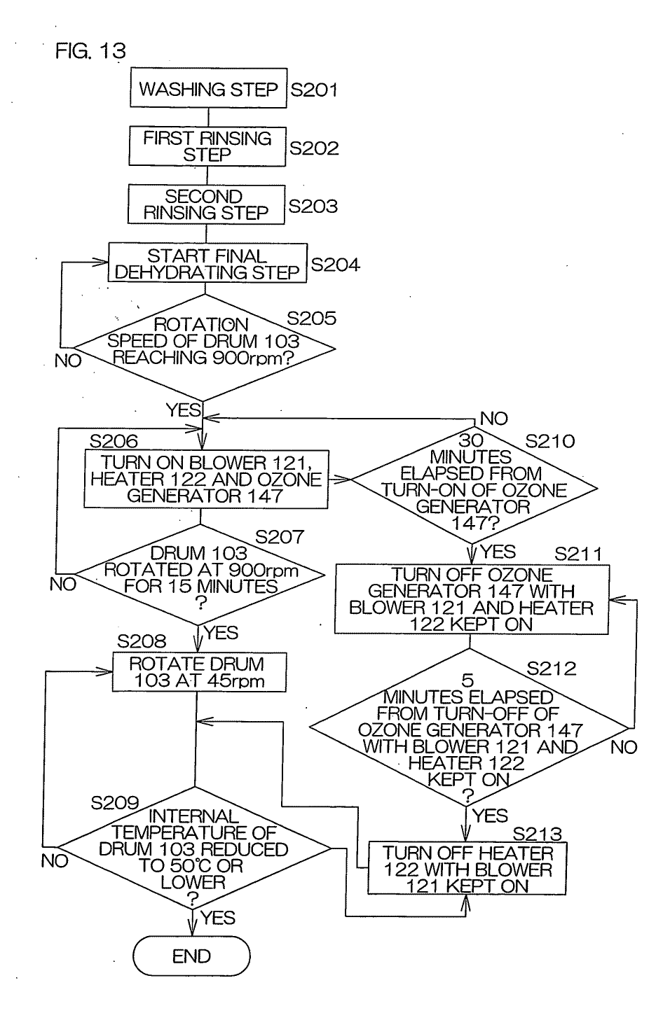

FIG. 13 is a flow chart for explaining a modification of the clothes sterilizing process of FIG. 12 to be performed with the use of the ozone in the final dehydrating operation. The sterilizing process of FIG. 13 differs from the embodiment shown in FIG. 12 in that the ozone generator 147 is turned on after the rotation speed of the drum 103 reaches 900 rpm and the water contained in the clothes is substantially removed.

After the washing step (Step S201), the first rinsing step (Step S202) and the second rinsing step (Step S203) are performed, the final dehydrating step is started (Step S204).

In the final dehydrating step, the rotation speed of the drum 103 is gradually increased in the same manner as shown in FIG. 12 after the washing process. If it is judged that the rotation speed of the drum 103 reaches a final dehydration rotation speed of 900 rpm (Yes in Step S205), the ozone generator 147, the blower 121 and the heater 122 are turned on (Step S206). When the rotation speed of the drum 103 reaches 900 rpm, the water contained in the clothes is substantially removed. Therefore, no water interferes with the ozone, so that the clothes deodorization and sterilization effects of the ozone are improved.

If it is judged that the drum 103 is rotated at 900 rpm for 15 minutes (Yes in Step S207), the final dehydrating step is terminated, and the drum 103 is rotated at a rotation speed of 45 rpm alternately in the normal direction and in the reverse direction (Step S208).

If it is judged that 30 minutes have elapsed after the turn-on of the ozone generator 147 (Yes in Step S210), the ozone generator 147 is turned off, and the sterilizing step is terminated (Step S211). At this time, the blower 121 and the heater 122 are not turned off, so that ozone-free air is circulated in the drum 103. Thus, the ozone consuming step is performed to cause all the ozone present in the housing 102 including the drum 103 to be consumed by the oxidation reaction.

If it is judged that five minutes have elapsed after the turn-off of the ozone generator 147 (Yes in Step S212), the heater 122 is turned off (Step S213), and the cooling step is started to cool the clothes to a predetermined temperature. Then, it is judged that the temperature measured by the temperature sensor 163, i.e., the temperature in the drum 103, is reduced to 50° C. or lower (Yes in Step S209), the cooling step is terminated.

In this embodiment, the control section 161 turns off the heater 122 after a lapse of five minutes from the turn-off of the ozone generator 147, but may turn off the heater 122 simultaneously with the turn-off of the ozone generator 147.

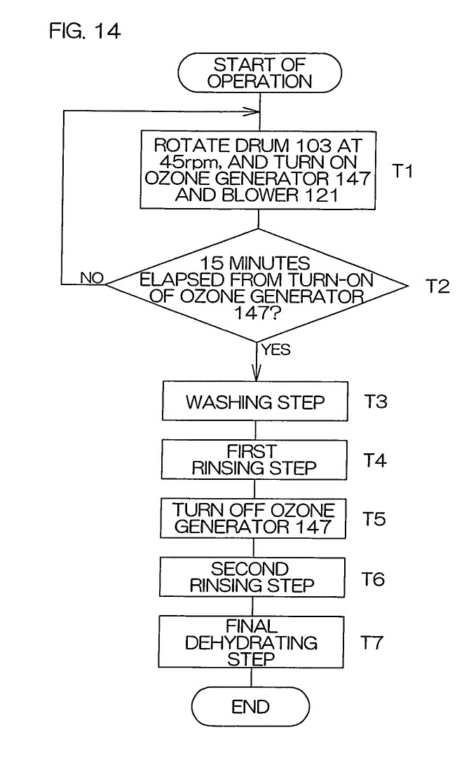

FIG. 14 is a flow chart of an ozone cleaning step. The ozone cleaning step is a cleaning step by a detergent-free course which includes cleaning, sterilizing and deodorizing (preliminary cleaning with the ozone) the clothes by supplying the ozone to the clothes before the washing step, at which the washing process is performed without the detergent. The ozone cleaning process is suitable for daily cleaning of less dirty clothes such as towels and underwear. Without the use of the detergent, the water used for the washing is environmentally friendly even if the water is drained out of the housing 102.

When the operation of the washing machine 101 is started, the ozone generator 147 is turned on, and the drum 103 is rotated at a rotation speed of 45 rpm alternately in the normal direction and in the reverse direction. Further, the blower 121 is turned on (Step T1). Thus, the ozone-containing air is supplied into the drum 103 to be applied to the clothes in the drum 103, whereby the clothes is preliminarily cleaned with the ozone. Thus, the ozone is effectively applied to dry clothes before the washing step, so that bacteria adhering to the clothes are oxidized to be decomposed into more water-soluble substances, which can be easily removed from the clothes by washing the clothes with water without the use of the detergent in the subsequent washing step. Thus, the cleaning effect is improved. Further, the deodorization and sterilization effects are also improved.

In this embodiment, the heater 122 is not turned on, but may be turned on to heat the ozone-containing air for activating the ozone.

If it is judged that the preliminary ozone cleaning step is performed for 15 minutes (Yes in Step T2), the washing step is performed (Step T3).

In this embodiment, the clothes are washed with water without the use of the detergent in the washing step, but the washing step may be performed with the use of the detergent. Further, a steam cleaning process may be performed by ejecting steam into the drum 103 before the washing step. In this case, the clothes are heated to a higher temperature by the steam, so that sebum is raised out of the clothes for easy removal thereof. This also improves the cleaning effect.

After completion of the washing step, the first rinsing step is performed (Step T4). After completion of the first rinsing step, the ozone generator 147 is turned off (Step T5).

After the turn-off of the ozone generator 147, the second rinsing step (Step T6) and the dehydrating step (Step T7) are performed. Thus, the ozone cleaning step is terminated.

In this embodiment, the ozone generator 147 is turned off after the completion of the first rinsing step, but may be turned off at different timing, for example, before the washing step or before the dehydrating step.

It should be understood that the present invention be not limited to the embodiments described above, but various modifications may be made within the scope of the present invention defined by the claims. The embodiments are directed to the washing machines of the tilted drum structure having the clothes drying function, but the present invention is applicable to a washing machine or a clothes drier having a horizontal drum or a vertical drum.

1. A clothes drier comprising:
a treatment tub in which clothes are dried;
a drying air duct having opposite ends and configured to feed air supplied from one of the opposite ends into the treatment tub, the other end being connected to the treatment tub;
an air blowing unit provided in the drying air duct and configured to generate an air stream for feeding the air supplied from the one end into the treatment tub through the other end;
a heating unit provided in the drying air duct for heating air flowing through the drying air duct; and
an ozone generator disposed outside the drying air duct for generating ozone from air sucked from an inlet thereof and releasing the ozone from an outlet thereof, the outlet being connected to a portion of the drying air duct upstream of the air blowing unit with respect to an air flowing direction.

2. A clothes drier comprising:
a treatment tub in which clothes are dried;
a drying air duct having opposite ends and configured to feed air supplied from one of the opposite ends into the treatment tub, the other end being connected to the treatment tub;
an air blowing unit provided in the drying air duct and configured to generate an air stream for feeding the air supplied from the one end into the treatment tub through the other end;
a heating unit provided in a portion of the drying air duct downstream of the air blowing unit with respect to an air flowing direction in the drying air duct for heating air flowing through the drying air duct;
an ozone generator disposed outside the drying air duct for generating ozone from air sucked from an inlet thereof and releasing the ozone from an outlet thereof, the inlet being connected to a portion of the drying air duct located between the air blowing unit and the heating unit, the outlet being connected to a portion of the drying air duct downstream of the heating unit with respect to the air flowing direction.

3. The clothes drier according to claim 2, further comprising a dehumidifying unit provided in the drying air duct for dehumidifying the air flowing through the drying air duct,
wherein the drying air duct is configured to circulate the air in the treatment tub with the one end thereof being connected to the treatment tub.

4. A clothes drier comprising:
a treatment tub in which a drying operation is performed to dry clothes;
an ozone generator which generates ozone;
a dryness detecting unit which detects dryness of the clothes in the treatment tub; and
an ozone supply controller which supplies the ozone generated by the ozone generator into the treatment tub after the dryness detected by the dryness detecting unit reaches a predetermined dryness level.

5. The clothes drier according to claim 4, wherein the ozone supply controller stops the supply of the ozone before completion of the drying operation performed in the treatment tub in consideration of time required for the ozone to be consumed in the treatment tub by an oxidation reaction before the completion of the drying operation.

6. The clothes drier according to claim 4,
wherein a cooling step is performed to reduce an increased temperature of the clothes in the drying operation,
wherein the ozone supply controller stops the supply of the ozone before completion of the cooling step.

7. The clothes drier according to claim 4,
wherein a cooling step is performed to reduce an increased temperature of the clothes after a drying step in the drying operation,
wherein the ozone supply controller supplies the ozone into the treatment tub during the cooling step.

8. A clothes drier comprising:
a treatment tub in which clothes are dried;
a drying air duct having opposite ends and configured to feed air supplied from one of the opposite ends into the treatment tub, the other end being connected to the treatment tub;
an air blowing unit provided in the drying air duct and configured to generate an air stream for feeding the air supplied from the one end into the treatment tub through the other end;
a heating unit provided in the drying air duct for heating air flowing through the drying air duct;
an ozone generator disposed outside the drying air duct for generating ozone; and
an ozone supply controller which supplies the ozone generated by the ozone generator into the treatment tub through the drying air duct;
the clothes drier being configured to perform a drying step of introducing the heated air into the treatment tub to dry the clothes in the treatment tub by actuating the air blowing unit and the heating unit, and a cooling step of reducing a temperature of the clothes in the treatment tub after completion of the drying step;
wherein the ozone supply controller supplies the ozone generated by the ozone generator into the treatment tub during the cooling step.

9. The clothes drier according to claim 8,
wherein the cooling step includes a sterilizing step of supplying the ozone into the treatment tub in a first half period, and an ozone consuming step of causing the ozone supplied in the sterilizing step to be consumed by an oxidation reaction in a second half period,
wherein the cooling step is terminated only after a lapse of a predetermined period from start of the ozone consuming step.

10. A washing machine with a clothes drying function, comprising a clothes drier as recited in claim 4,
wherein the treatment tub is a tub in which water is contained and the clothes are washed and dehydrated before the drying of the clothes.

11. A washing machine comprising:
a treatment tub in which clothes are contained and the contained clothes are washed and dehydrated;
an ozone generator which generates ozone; and
an ozone supply controller which supplies the ozone generated by the ozone generator into the treatment tub;
wherein the ozone supply controller supplies the ozone generated by the ozone generator into the treatment tub during a dehydrating step performed to dehydrate the clothes.

12. The washing machine according to claim 11,
wherein the treatment tub includes a rotary drum to be rotated about a rotation axis,
wherein the ozone supply controller supplies the ozone generated by the ozone generator into the treatment tub after a rotation speed of the rotary drum reaches a predetermined dehydration rotation speed.

13. The washing machine according to claim 12, further comprising an agitator which agitates the clothes,
wherein the ozone supply controller supplies the ozone into the treatment tub after the dehydrating step while causing the agitator to agitate the clothes.

14. A washing machine comprising:
a treatment tub in which clothes are contained, and the contained clothes are washed and dehydrated;
an ozone generator which generates ozone; and
an ozone supply controller which supplies the ozone generated by the ozone generator into the treatment tub;
the washing machine being configured to perform a laundering operation which is terminated after the dehydration of the clothes;
wherein the ozone supply controller supplies the ozone generated by the ozone generator into the treatment tub after the dehydration of the clothes in the laundering operation.

15. The washing machine according to claim 11, further comprising:
an air duct having opposite ends and configured to feed air supplied from one of the opposite ends into the treatment tub, the other end being connected to the treatment tub;
an air blowing unit provided in the air duct and configured to generate an air stream for feeding the air supplied from the one end into the treatment tub through the other end; and
a heating unit provided in the air duct for heating air flowing through the air duct,
wherein the ozone generator is connected to the air duct;
wherein the ozone supply controller supplies the ozone together with the heated air flowing through the air duct into the treatment tub by actuating the air blowing unit and the heating unit during the supply of the ozone.

16. A washing machine with a clothes drying function, comprising:
a treatment tub in which water is contained, and a washing process, a dehydrating process and a drying process are performed with clothes being contained therein;
a drying air duct having opposite ends and configured to feed air supplied from one of the opposite ends into the treatment tub, the other end being connected to the treatment tub;
an air blowing unit provided in the drying air duct and configured to generate an air stream for feeding the air supplied from the one end into the treatment tub through the other end;
a heating unit provided in the drying air duct for heating air flowing through the drying air duct;
an ozone generator disposed outside the drying air duct for generating ozone;
an ozone supply controller which supplies the ozone generated by the ozone generator into the treatment tub through the drying air duct; and
a selector which selects one of a washing course in which the washing process and the dehydrating process are performed, a washing/drying course in which the washing process, the dehydrating process and the drying process are performed, and a drying course in which the drying process is performed;
wherein the ozone supply controller supplies the ozone into the treatment tub during the dehydrating step to dehydrate the clothes and/or after the dehydrating step if the washing course is selected, and supplies the ozone into the treatment tub during the drying operation if the washing/drying course or the drying course is selected.

17. A washing machine comprising:
a treatment tub in which clothes are contained, and the contained clothes are washed;
an ozone generator which generates ozone; and
an ozone supply controller which supplies the ozone generated by the ozone generator into the treatment tub;
wherein the ozone supply controller supplies the ozone generated by the ozone generator into the treatment tub before water is supplied in a washing step.

18. The washing machine according to claim 17, further comprising a heating unit which heats an inside of the treatment tub before and/or during the supply of the ozone by the ozone supply controller.

19. The washing machine according to claim 17, further comprising a load detecting unit which detects an amount of the clothes contained in the treatment tub,
wherein the ozone supply controller supplies the ozone into the treatment tub only when the load detected by the load detecting unit is greater than a predetermined level.

20. The washing machine according to claim 17,
wherein in response to a detergent-free washing signal applied to the washing machine, the ozone supply controller performs a detergent-free washing course in which the ozone is supplied into the treatment tub and subsequently to the supply of the ozone the clothes contained in the treatment tub are washed without a detergent and then rinsed.
